(19) United States
(12) Patent Application Publication
(10) Pub. No.: US 2021/0268763 A1
(43) Pub. Date: Sep. 2, 2021

(54) FOLDED CORE STRUCTURE AND PROCESS FOR PROVIDING A FOLDED CORE STRUCTURE

(71) Applicants: LOW & BONAR GERMANY GMBH & CO. KG, Erlenbach (DE); LOW & BONAR B.V., Arnhem (NL); LOW & BONAR INC., Enka, NC (US)

(72) Inventors: Rolf-Dieter BÖTTCHER, Kleve (DE); Jan MAHY, Arnhem (NL); Jeffrey DENTON, Canton, NC (US)

(73) Assignees: LOW & BONAR GERMANY GMBH & CO. KG, Erlenbach (DE); LOW & BONAR B.V., Arnhem (NL); LOW & BONAR INC., Enka, NC (US)

(21) Appl. No.: 17/258,831

(22) PCT Filed: Jul. 2, 2019
(86) PCT No.: PCT/EP2019/067772

§ 371 Date: Jan. 8, 2021

(30) Foreign Application Priority Data
Jul. 24, 2018 (EP) 18185241.9

(51) Int. Cl. B32B 3/12; B29C 53/06; B29D 99/00; B32B 3/28; B32B 5/02

(52) U.S. Cl. CPC B32B 3/12; B29C 53/063; B29L 2031/608; B32B 3/28; B32B 5/022; B29D 99/0089

(57) ABSTRACT

A folded core structure formed from an uncut flat body, has a plurality of consecutive 3D-structures and connecting areas each formed by plastic deformation, and includes first and second primary surfaces oriented plane-parallel to each other. The first and second primary surfaces include a first secondary surface extending over the entire width of the folded core structure and extending over a part of the length of the folded core structure. The first secondary surface is oriented parallel to the first primary surface, and the first secondary surface is located at a distance from the first primary surface between the first and second primary surfaces. A channel for fluid flow at least along the width of the folded core structure is provided. The first and/or second primary surface is/are configured to provide dimensional stability under a compression force applied perpendicular to the first primary surface of the folded core structure.

The invention pertains to folded core structures and to processes for providing such folded core structures.

In many cases, core structures are provided in the form of honeycomb structures, consisting of an array of adjacent cells, wherein the cells preferably have a hexagonal cross section.

Core structures can for example be manufactured by injection moulding. The disadvantage of an injection molding technique is that it yields only structures of limited size due to the inherent restrictions in the dimensions of the mold to be used. Furthermore, the cycle time in an injection molding process is relatively long limiting the production output of the process. The material of which the core structure is composed has to fulfill certain flow characteristics in order to able to fill the mold completely.

Honeycomb structures may also be formed by stacking successive layers of corrugated sheets comprising half-hexagonal corrugations and bonding the corrugated sheets to one another, as for example disclosed by U.S. Pat. No. 3,356,555. Such a process, however, requires extensive handling of material, including cutting strips of sheet from a material layer, stacking strips of corrugated sheet at high accuracy and bonding the stack of corrugated sheets to each other.

Honeycomb structures made from a continuous sheet of material do not have capability for fluid flow in the plane of the honeycomb structure and/or do not have sufficient dimensional stability under a compression force applied perpendicular to the plane of the core structure.

WO 2006/053407 A1 discloses a folded honeycomb structure which is produced from an uncut continuous web of material by plastic deformation perpendicular to the plane of the material to thereby form half-hexagonal cell walls and small connecting areas. By folding the plastically deformed material in the direction of conveyance the half-hexagonal cell walls meet to form the honeycomb structure.

WO 2006/053407 A1 further discloses that the plastically deformed material is folded such that the cell walls may not be fully vertical. However, such a structure may not provide sufficient dimensional stability when a compression force is applied perpendicular to the plane of the honeycomb structure as compared to a honeycomb structure wherein the cell walls are oriented fully vertical, as a result of which the folded structure may collapse under the compression force applied perpendicular to the plane of the honeycomb structure.

The object of the invention is to provide a folded core structure which exhibits sufficient dimensional stability under a compression force applied perpendicular to the plane of the folded core structure and has capability for fluid flow in at least one direction in the plane of the folded core structure, and to provide a process for forming such folded core structures.

The object of the invention is solved by the folded core structure according to claim 1 and by the process according to claim 10.

A folded core structure is provided which has a capability for fluid flow at least along the width of the folded core structure while having sufficient dimensional stability under a compression force applied perpendicular to the plane of the folded core structure, when the folded core structure is formed from a substantially uncut flat body, the folded core structure having a plurality of consecutive 3D-structures formed by plastic deformation and connecting areas between consecutive 3D-structures formed by the plastic deformation, the folded core structure comprising a first primary surface and a second primary surface oriented plane-parallel to the first primary surface, wherein the first primary surface and the second primary surface are defined by a length and a width of the folded core structure, and comprising a first secondary surface extending over the entire width of the folded core structure and extending over a part of the length of the folded core structure, wherein the first secondary surface is oriented parallel to the first primary surface and wherein the first secondary surface is located at a distance from the first primary surface between the first primary surface and the second primary surface, wherein a channel for fluid flow at least along the width of the folded core structure is provided, the circumference of the channel for fluid flow being formed by the first secondary surface, the connecting areas or a part of the 3D-structures, and the first primary surface, and wherein the first primary surface and/or the second primary surface is/are configured such to provide dimensional stability under a compression force applied perpendicular to the first primary surface of the folded core structure.

The term formed from a substantially uncut flat body is understood to mean that the flat body is not cut to enable folding of the deformed sheet into a folded core structure. The substantially uncut flat body may however be cut to provide a certain width and/or length of the flat body before the flat body is plastically deformed. It is therefore to be understood that folded core structure is formed from an uncut flat body.

The length of the folded core structure is the dimension of the folded core structure in the production direction of the folded core structure, also known as machine direction or the principal direction, and can be indefinite in case of continuous production.

The width of the folded core structure is the dimension of the folded core structure perpendicular to the production direction in the plane of the folded core structure, also known as the cross machine direction.

The thickness of the folded core structure is the dimension of the folded core structure perpendicular to the length and the width of the folded core structure, and corresponds to the distance between the first primary surface and the second primary surface.

The thickness of the uncut flat body which is to be plastically deformed and folded into a folded core structure may be varied widely. Preferably, the thickness of the uncut flat body will be in the range of 0.1 mm to 2.0 mm. When the thickness of the uncut flat body is selected to be less than 0.1 mm, the risk of tearing the uncut flat body during plastically forming consecutive 3D-structures increases. When the thickness of the uncut flat body is selected to be more than 2.0 mm, plastically forming consecutive 3D-structures in the uncut flat body becomes more difficult due to increased stiffness of the uncut flat body and/or the uniform heating of the uncut flat body becomes more difficult. More preferably, the thickness of the uncut flat body will be in the range of 0.2 mm to 0.5 mm. Most preferably the thickness of the uncut flat body is 0.3 mm to 0.4 mm for an optimum balance between formability of 3D-structures without tearing the uncut flat body.

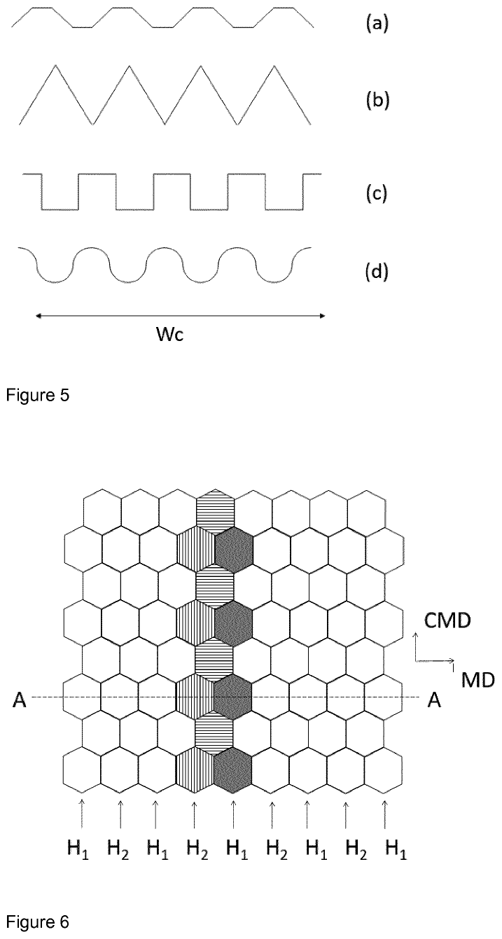

The 3D-structures plastically formed in the uncut flat body may in principle be of any shape in the cross machine direction, such as for example a shape of half-hexagons, a triangular shape, a crenellation shape or a sinusoidal shape. FIG. 5a schematically depicts a series of half-hexagons. The base width and the height of the half-hexagons may vary widely. FIG. 5b schematically depicts a series of triangular shapes. The base width and the height of the triangular shapes may vary widely. FIG. 5c schematically depicts a series of crenellation shapes. The base width and the height of the crenellation shapes may vary widely. FIG. 5d schematically depicts a series of sinusoidal shapes. The period and the amplitude of the sinusoidal shapes may vary widely.

In one embodiment, the 3D-structures preferably have a half-hexagonal shape to provide for optimum use of material in respect of mechanical stability and/or density of the folded core structure.

In another embodiment, the 3D-structures preferably have a sinusoidal shape to prevent, or at least reduce, the formation of stress concentrations in the folded core structure upon subjecting the folded core structure to an external force.

The uncut flat body may also comprise any combination of plastically formed 3D-structures with different shapes. However, the 3D-structures plastically formed in the uncut flat body preferably have a shape which is constant along the length of each individual 3D-structure. The 3D-structures plastically formed in the uncut flat body are thus preferably not provided with cell walls having a 3D shape, such as a bowed, curved or undulating shape as disclosed by EP 1995052 A1, to provide increased dimensional stability under a compression force applied perpendicular to the plane of the folded core structure.

In an embodiment, the 3D-structures plastically formed in the uncut flat body are provided by supplying an uncut flat body, plastically deforming the uncut flat body, wherein the material of the uncut flat body is heated to soften the material, plastically forming 3D-structures by pressing the heated flat uncut flat body onto a profiled surface, and cooling the plastically deformed uncut flat body. Preferably, the uncut flat body is heated to a temperature below the melting temperature of the material of the uncut flat body, but to at least 50° C. below the melting temperature of the material of the uncut flat body, more preferably to a temperature of at least 20° C. below the melting temperature of the material of the uncut flat body for improved formation of the 3D-structures.

The melting temperature of the material comprised in the first sheet of material, in particular when the material is a thermoplastic polymer, is determined by Differential Scanning calorimetry (DSC) as the temperature at the maximum value of the endothermic melting peak upon heating of the material at a rate of 20° C./min.

The uncut flat body may be pressed onto a profiled surface by a vacuum supplied below the profiled surface, the profiled surface being porous such that the vacuum acts on the heated uncut flat body. A particularly suitable process is rotational vacuum thermoforming, as disclosed in WO 2006/053407 A1.

The uncut flat body comprising plastically formed 3D-structures is provided with folding lines extending in the cross machine direction of the uncut flat body, thereby providing consecutive 3D-structures between two consecutive folding lines. The folding lines may be provided without making cuts in the flat body. The folding lines can be provided simultaneously with the plastic formation of the 3D-structures in the uncut flat body.

The thickness of the plastically deformed flat body may be varied widely, and depends on the dimensions of the 3D-structures. In an embodiment, the thickness of the plastically deformed flat body is at least 3 mm, preferably at least 5 mm. When the thickness of the plastically deformed flat body is less than 3 mm, the reduction in product mass of the folded core structure will be limited as compared to a continuous sheet of material provided with grooves.

In an embodiment, the thickness of the plastically deformed flat body is at most 100 mm, preferably at most 50 mm. When the thickness of the plastically deformed flat body is more than 100 mm, forming the 3D-structures without tearing the first sheet of material will become increasingly difficult.

The plastically deformable material of the uncut flat body may be a thin thermoplastic polymeric material, a fiber composite material, a plastically deformable paper or a metal sheet or similar.

FIG. 1 schematically depicts a section of an uncut flat body made of a plastically deformable material which has been plastically deformed to form a plurality of consecutive 3D-structures and connecting areas between consecutive the 3D-structures.

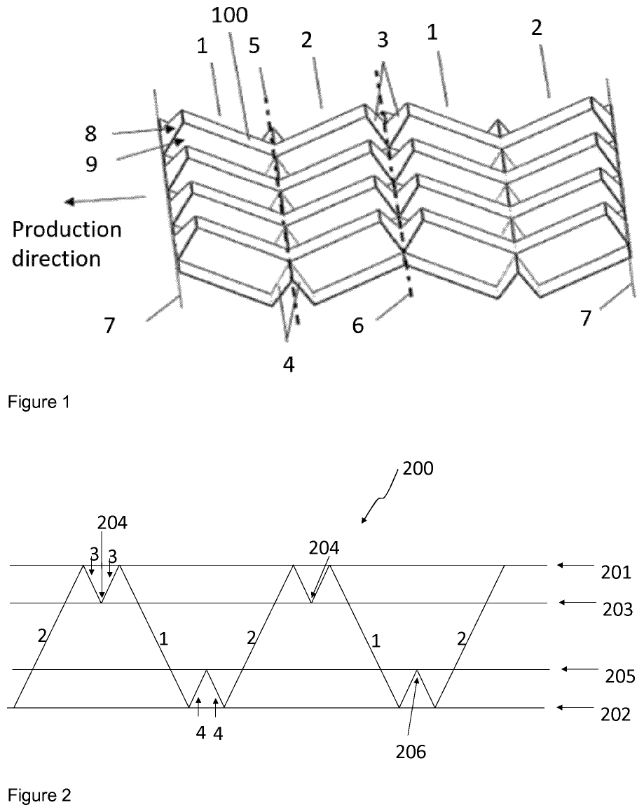

FIG. 2 schematically depicts a side view of a folded core structure according to an embodiment of the invention.

FIG. 3 schematically depicts a side view of a folded core structure according to another embodiment of the invention.

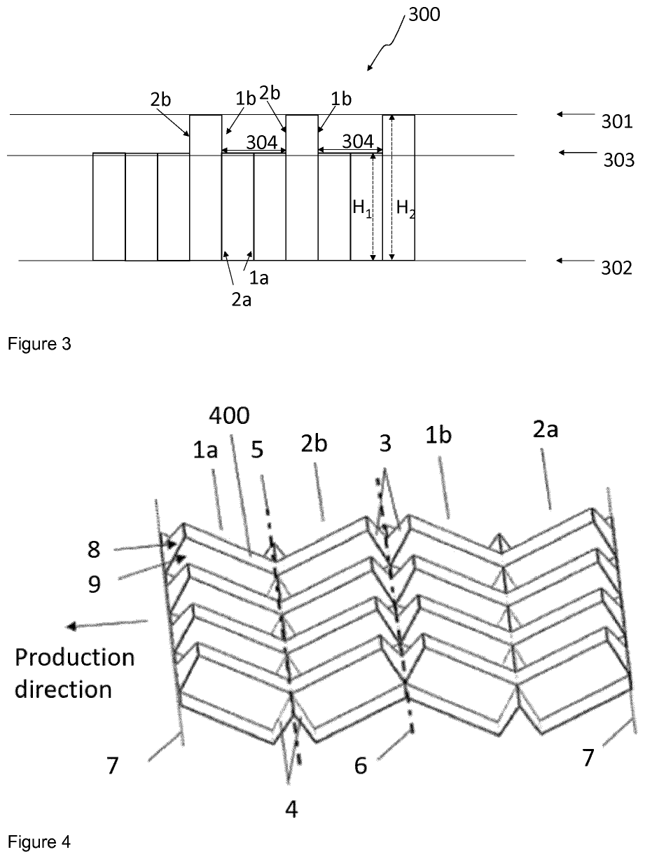

FIG. 4 schematically depicts a section of an uncut flat body made of a plastically deformable material which has been plastically deformed to form a plurality of consecutive 3D-structures and connecting areas between consecutive the 3D-structures according to another embodiment of the invention.

FIG. 5 schematically depicts various shapes of 3D-structures.

FIG. 6 is a schematic top view representation of an exemplary folded core structure consisting of an array of adjacent hexagonal cells, the array extending in a length direction (MD) and in a width direction (CMD) of the folded core structure.

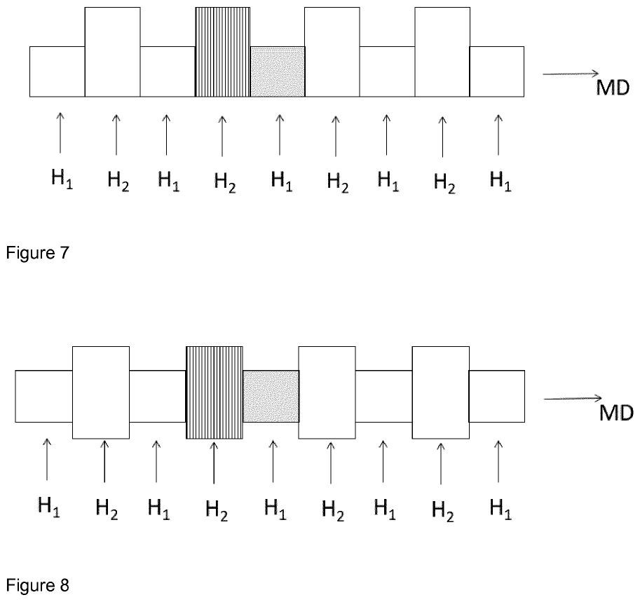

FIG. 7 is a schematic side view representation of the exemplary core structure of FIG. 6 along line A-A.

FIG. 8 is a schematic side view representation of an exemplary core structure.

FIG. 1 schematically depicts a section of an uncut flat body (100) made of a plastically deformable material which has been plastically deformed to form a plurality of consecutive 3D-structures (1, 2).

The uncut flat body has been plastically deformed into consecutive 3D-structures (1, 2) formed mainly perpendicular to the plane of the uncut flat body. In the regions 1 and 2, the material of the uncut flat body has been deformed into three-dimensional (3D) structures, e.g. having a polygonal shape, for example a half-hexagonal shape, a triangular shape, a crennelation shape and/or a sinusoidal shape, extending mainly perpendicular from the plane of the uncut flat body. The uncut flat body which has been plastically deformed into consecutive 3D-structures is provided with folding lines (5, 6) extending perpendicular to the length direction of the plastically deformed body, i.e. extending in cross machine direction, thereby providing consecutive 3D-structures between two consecutive folding lines.

The plastic deformations form ridges 8 and valleys 9 whereby each of these is not continuous, thus forming consecutive 3D-structures. For example, the ridges are composed of a linear series of consecutive 3D-structures (1, 2). Preferably, the ridges have a top surface that may be initially (e.g. as deformed) parallel to the plane of the uncut flat body. The production direction is preferably as shown in FIG. 1, however, a direction perpendicular thereto (parallel to the axes 5 and 6) could be used as well. Connecting areas (3, 4) are formed simultaneously during plastic deformation of the uncut flat body.

The 3D-structures (1, 2) are preferably formed by plastic deformation of the uncut flat body inclined to the plane of the uncut flat body, i.e. rotated towards each other around the axis 5 and/or 6, to form u- or v-shaped connecting areas 3 and 4. The connecting areas 3 and 4 separate the consecutive 3D-structures (1, 2). One connecting area 3, 4 is placed between two consecutive 3D-structures and connecting areas 3 alternate along the row of consecutive 3D-structures (1, 2) with connecting areas 4. The connecting areas 3, 4 form cross-valleys, i.e.

perpendicular to the valleys 9. Adjacent cross-valleys are on opposite sides of the plastically deformed body. The rotation of the consecutive 3D-structures (1, 2) to bring them into the initial position of FIG. 1 is preferably performed simultaneously with the deformations formed into the uncut flat body. The uncut flat body is stretched during the plastic deformation at the transitions between the consecutive 3D-structures (1, 2) to form the connecting areas 3 and 4, which are substantially perpendicular to the outer surfaces of the consecutive 3D-structures (1, 2). The angle between surfaces 3 or 4 on different ridge sections, allows a part of a tool to enter and thus to form the connecting areas 3 or 4.

The plastic deformation of the uncut flat body serves the purpose of forming three-dimensional structures (1, 2), which may form the walls of cell halves in the folded core structure. The cells structures thus formed may be structural and load bearing elements of the folded end product. In the folded core structure, the cell structures formed by folding to a predefined angle of 180° may be cylindrical in cross section, the axis of the cylinder extending perpendicular to the plane of the first primary surface of the folded core structure. The cross-sectional shape of a cell may however be selected as desired, for example circular, diamond shape, square or polygonal, in particular even-numbered polygonal, for example hexagonal.

The final cell shape is determined by the shape of the 3D-structures (1, 2) in the formed in the uncut flat body and how the 3D-structures are folded together. When the 3D-structures are folded to a predefined angle of 180° the core structure is fully folded to provide an array of adjacent cell structures, the array extending over the length of the folded core structure and extending over the width of the folded core structure, the cell structures in the array being arranged in a series of adjacent rows of cell structures extending over the width of the folded core structure, wherein each cell structure is formed from two 3D-structures (1, 2). Each cell structure in the array is formed by the bottom and sides of two consecutive longitudinally adjacent (in the plastically deformed body) valley sections 9. The 3D-structures, or half cells, may preferably be joined together across touching surfaces of ridge sections 8. When the 3D-structures are folded to a predefined angle of 180°, at least a part of the cell walls may be wholly or partly permanently connected to one another, e.g. by glue or adhesive or welding.

The 3D-structures plastically deformed into the uncut flat body may include a mixture of different cross-sectional shapes and/or sizes.

Referring to FIG. 1, the process for providing a folded core structure continues by rotating the 3D-structures (1, 2) further so that the surfaces from consecutive 3D-structures are folded towards each to a predefined angle, either to angle of 180° or to an angle of more than 0° and less than 180°.

The predefined angle is the angle formed by a folding line (5, 6) and the consecutive 3D-structures (1, 2) on both sides of the folding line.

FIG. 2 depicts a side view of a folded core structure according to an embodiment of the invention.

Consecutive 3D-structures (1, 2) are folded towards each to a predefined angle of more than 0° and less than 180° to form a folded core structure (200). The folded core structure comprises a first primary surface (201) corresponding to the plane wherein ends of consecutive 3D-structues (1, 2) are located. The folded core structure comprises a second primary surface (202) corresponding to the plane wherein the opposite ends of consecutive 3D-structures are located. The first primary surface (201) and/or the second primary surface (202) is/are configured such to provide dimensional stability under a compression force applied perpendicular to the first primary surface of the folded core structure, e.g. by a sheet of material laminated to the plurality of consecutive 3D-structures (1, 2).

The term laminated is understood to mean that a sheet of material is connected to the plurality of consecutive 3D-structures. Connecting the sheet of material to the the plurality of consecutive 3D-structures may be performed by any suitable method, including but not limited to a mechanical method, such as for example mechanical needling or sewing, an adhesive method, such as for example by applying a hot-melt or a glue, or by applying an adhesive web between the sheet of material and the plurality of consecutive 3D-structures, or a thermal bonding method, such as for example heating in an oven, heating by through air bonding or by ultrasonic bonding.

The folded core structure (200) further comprises a first secondary surface (204) extending over the entire width of the folded core structure and extending over a part of the length of the folded core structure, wherein the first secondary surface (204) is oriented parallel (in a plane, 203) to the first primary surface (201) and wherein the first secondary surface is located at a distance from the first primary surface between the first primary surface (201) and the second primary surface (202). The folded core structure of FIG. 2 is thus configured to provide a capability for fluid flow at least along the width of the folded core structure as a channel for fluid flow is provided, the circumference of the channel for fluid flow being formed by the first secondary surface (204), the connecting areas (3) and the first primary surface (201).

The folded core structure (200) may further comprise a second secondary surface (206), extending over the entire width of the folded core structure and extending over a part of the length of the folded core structure, wherein the second secondary surface (206) is oriented parallel (in a plane, 205) to the second primary surface (202) and wherein the second secondary surface (206) is located at a distance from the second primary surface between the first primary surface (201) and the second primary surface (202). The second secondary surface provides additional capability for fluid flow at least along the width of the folded core structure as an additional channel for fluid flow is provided, the circumference of the channel for fluid flow being formed by the second secondary surface (206), the connecting areas (4) and the second primary surface (202).

The folded core structure (200) may comprise more than one first secondary surfaces (204) to provide multiple flow channels for fluid flow along the width of the folded core structure. The more than one first secondary surfaces (204) may all be located in plane 203 oriented plane-parallel to the first primary surface (201). However, the folded core structure may comprise more than one first secondary surfaces (204), which are located at different distances from the first primary surface, for example by varying the dimensions of consecutive 3D-structures and/or by varying the predefined angle to which the consecutive 3D-structures are folded.

Likewise, the folded core structure (200) may comprise more than one second secondary surfaces (206) to provide multiple flow channels for fluid flow along the width of the folded core structure. The more than one second secondary surfaces (206) may all be located in plane 205 oriented plane-parallel to the second primary surface (202. However, the folded core structure may comprise more than one second secondary surfaces (206), which are located at different distances from the second primary surface, for example by varying the dimensions of consecutive 3D-structures and/or by varying the predefined angle to which the consecutive 3D-structures are folded.

The folded core structure (200) is also configured to provide a capability for fluid flow along the length of the folded core structure when the consecutive 3D-structures (1, 2) are folded towards each to a predefined angle of more than 0° and less than 180°, as a channel for fluid flow is provided by the ridges 8 and valleys 9 (see FIG. 1).

FIG. 4 schematically depicts a section of an uncut flat body made of a plastically deformable material which has been plastically deformed to form a plurality of consecutive 3D-structures and connecting areas between consecutive the 3D-structures according to another embodiment of the invention.

The uncut flat body has been plastically deformed into consecutive 3D-structures (1a, 2a; 1b, 2b) formed mainly perpendicular to the plane of the uncut flat body. In the regions 1a, 1b, 2a and 2b, the material of the uncut flat body has been deformed into three-dimensional (3D) structures, e.g. having a polygonal shape, for example a half-hexagonal shape, a triangular shape, a crennelation shape and/or a sinusoidal shape, extending mainly perpendicular from the plane of the uncut flat body. The uncut flat body which has been plastically deformed into consecutive 3D-structures is provided with folding lines (5, 6) extending perpendicular to the length direction of the plastically deformed body (400), i.e. extending in cross machine direction, thereby providing consecutive 3D-structures between two consecutive folding lines.

The plastic deformations form ridges 8 and valleys 9 whereby each of these is not continuous, thus forming consecutive 3D-structures. For example, the ridges are composed of a linear series of consecutive 3D-structures (1a, 2a, 1b, 2b). Preferably, the ridges have a top surface that may be initially (e.g. as deformed) parallel to the plane of the uncut flat body. The production direction is preferably as shown in FIG. 4, however, a direction perpendicular thereto (parallel to the axes 5 and 6) could be used as well. Connecting areas (3, 4) are formed simultaneously during plastic deformation of the uncut flat body.

The 3D-structures (1a, 2a, 1b, 2b) are preferably formed by plastic deformation of the uncut flat body inclined to the plane of the uncut flat body, i.e. rotated towards each other around the axis 5 and/or 6, to form u- or v-shaped connecting areas 3 and 4. The connecting areas 3 and 4 separate the consecutive 3D-structures (1a, 2b, 1b, 2a). One connecting area 3, 4 is placed between two consecutive 3D-structures and connecting areas 3 alternate along the row of consecutive 3D-structures (1a, 2b, 1b, 2a) with connecting areas 4. The connecting areas 3, 4 form cross-valleys, i.e. perpendicular to the valleys 9. Adjacent cross-valleys are on opposite sides of the plastically deformed body. The rotation of the consecutive 3D-structures (1a, 2b, 1b, 2a) to bring them into the initial position of FIG. 4 is preferably performed simultaneously with the deformations formed into the uncut flat body. The uncut flat body is stretched during the plastic deformation at the transitions between the consecutive 3D-structures (1a, 2b, 1b, 2a) to form the connecting areas 3 and 4, which are substantially perpendicular to the outer surfaces of the consecutive 3D-structures (1a, 2b, 1b, 2a). The angle between surfaces 3 or 4 on different ridge sections, allows a part of a tool to enter and thus to form the connecting areas 3 or 4.

The plastic deformation of the uncut flat body serves the purpose of forming three-dimensional structures (1a, 2b, 1b, 2a), which may form the walls of cell halves in the folded core structure. The cells structures thus formed may be structural and load bearing elements of the folded end product. In the folded core structure, the cell structures formed by folding to a predefined angle of 180° may be cylindrical in cross section, the axis of the cylinder extending perpendicular to the plane of the first primary surface of the folded core structure. The cross-sectional shape of a cell may however be selected as desired, for example circular, diamond shape, square or polygonal, in particular even-numbered polygonal, for example hexagonal.

The final cell shape is determined by the shape of the 3D-structures (1a, 2b, 1b, 2a) formed in the uncut flat body and how the 3D-structures are folded together. When the 3D-structures are folded to a predefined angle of 180° the core structure is fully folded to provide an array of adjacent cell structures, the array extending over the length of the folded core structure and extending over the width of the folded core structure, the cell structures in the array being arranged in a series of adjacent rows of cell structures extending over the width of the folded core structure, wherein each cell structure is formed from two 3D-structures (1a, 2a; 1b, 2b). Each cell structure in the array is formed by the bottom and sides of two consecutive longitudinally adjacent (in the plastically deformed body) valley sections 9. The 3D-structures, or half cells, may preferably be joined together across touching surfaces of ridge sections 8. When the 3D-structures are folded to a predefined angle of 180°, at least a part of the cell walls may be wholly or partly permanently connected to one another, e.g. by glue or adhesive or welding. In the embodiment of FIGS. 3 and 4, the 3D-structures are plastically formed in the uncut flat body, whereby the 3D-structures have different lengths. The 3D-structures 1b and 2b have equal lengths corresponding to the height H₂ of FIG. 3, while the 3D-structures 1a and 2a have equal lengths corresponding to the height H₁ in the folded core structure of FIG. 3. The length of 3D-structures 1b and 2b is thus larger than the length of 3D-structures 1a and 2a.

The 3D-structures plastically deformed into the uncut flat body may include a mixture of different cross-sectional shapes and/or sizes.

Referring to FIG. 4, the process for providing a folded core structure continues by rotating the 3D-structures (1, 2) further so that the surfaces from consecutive 3D-structures are folded towards each to a predefined angle of 180° to provide an array of adjacent cell structures, the array extending over the length of the folded core structure and extending over the width of the folded core structure, the cell structures in the array being arranged in a series of adjacent rows of cell structures extending over the width of the folded core structure, the array comprising a row of first cell structures and a row of second cell structures, wherein the cell structures of the row of second cell structures are in direct contact with the cell structures of the row of first cell structures, wherein the cell structures of the row of second cell structures have a height, H₂, which is greater than the height, H₁, of the cell structures of the row of first cell structures characterized in that the difference in height H₂ of the row of second cell structures and the height H₁ of the row of first cell structures is a discrete step. FIG. 3 depicts a side view of a folded core structure.

Consecutive 3D-structures are folded towards each to a predefined angle of 180° to form a folded core structure (300). The folded core structure comprises a first primary surface (301) corresponding to the plane wherein ends of consecutive 3D-structures (1b, 2b) are located. The folded core structure comprises a second primary surface (302) corresponding to the plane wherein the opposite ends of consecutive 3D-structures are located.

The folded core structure (300) further comprises a first secondary surface (304), corresponding to the plane wherein ends of consecutive 3D-structures (1a, 2a) are located, extending over the entire width of the folded core structure and extending over a part of the length of the folded core structure, wherein the first secondary surface (304) is oriented parallel (in a plane, 303) to the first primary surface (301) and wherein the first secondary surface is located at a distance from the first primary surface between the first primary surface (301) and the second primary surface (302). The folded core structure of FIG. 3 is thus configured to provide a capability for fluid flow at least along the width of the folded core structure as a channel for fluid flow is provided, the circumference of the channel for fluid flow being formed by the first secondary surface (304), a part of the 3D-structures (i.e. defined by the difference in height between H₂ and H₁) and the first primary surface (301).

The folded core structure may further comprise a second secondary surface, extending over the entire width of the folded core structure and extending over a part of the length of the folded core structure, wherein the second secondary surface is oriented parallel to the second primary surface and wherein the second secondary surface is located at a distance from the second primary surface between the first primary surface and the second primary surface. The second secondary surface provides additional capability for fluid flow at least along the width of the folded core structure as an additional channel for fluid flow is provided, the circumference of the channel for fluid flow being formed by the second secondary surface, the connecting areas and the second primary surface.

The folded core structure (300) may comprise more than one first secondary surfaces (304) to provide multiple flow channels for fluid flow along the width of the folded core structure. The more than one first secondary surfaces (304) may all be located in plane 303 oriented plane-parallel to the first primary surface (301). However, the folded core structure may comprise more than one first secondary surfaces (304), which are located at different distances from the first primary surface, for example by varying the dimensions of consecutive 3D-structures.

Likewise, the folded core structure may comprise more than one second secondary surfaces to provide multiple flow channels for fluid flow along the width of the folded core structure, as for example schematically shown in FIG. 7. The more than one second secondary surfaces may all be located in a plane oriented plane-parallel to the second primary surface. However, the folded core structure may comprise more than one second secondary surfaces, which are located at different distances from the second primary surface, for example by varying the dimensions of consecutive 3D-structures.

In known honeycomb structures, the top of the adjacent cells are all located in a common plane forming the top surface of the honeycomb structure. Likewise, the bottom of the adjacent cells in honeycomb structures are also all located in a common plane forming the bottom surface of the honeycomb structure, the bottom surface being oriented plane-parallel to the top surface of the honeycomb structure. The resulting honeycomb structure is a structure having planar outer surfaces, thus basically having a plank-like outer shape and having high compression resistance, but no capability for fluid flow. By creating cell structures of different heights in the folded core structure, a capability for fluid flow is provided in the folded core structure, at least along the width of the folded core structure.

Additionally, by creating cell structures of different heights in the folded core structure, a certain level of resilience is provided to the core structure. Resilience in folded core structures is desirable in certain applications, for example for providing shock absorption and/or sound attenuation when applied under hard flooring such as for example under a wooden floor or under a floating cement floor.

The fact that the folded core structure comprises at least one row of second cell structures extending in the width direction of the folded core structure having an increased height H₂ as compared to the height H₁ of an adjacent row of first cell structures provides resilience to the folded core structure. When a static or dynamic load or force is applied (e.g. perpendicularly) onto the folded core structure, the row of second cell structures having an increased height H₂ will be subjected to a compressive force and will absorb at least a part of the compressive energy, for example by compression of the row of second cell structures having a height H₂ to a reduced height, for example by bulging of the cell walls of the second cell structures. The adjacent row of first cell structures having a lower height H₁ will not be loaded directly, or will at least be subjected to only a reduced load or force.

Upon increasing the load or force applied onto the folded core structure, the capability of absorbing compressive energy of the row of second cell structures having a height H₂ may become fully utilized, which will result in increased loading of the row of first cell structures having a height H₁. The load or force applied onto the core structure will then be distributed onto the row of second cell structures having a height H₂ as well as onto the row of first cell structures having a height H₁.

In an embodiment, the plurality of consecutive 3D-structures formed by plastic deformation form a predefined angle of more than 0° and less than 180° in the folded core structure. One could consider that the consecutive 3D-structures are not fully folded together in the core structure when consecutive 3D-structures form a predefined angle of more than 0° and less than 180° in the folded core structure. As the 3D-structures formed by plastic deformation form a predefined angle of more than 0° and less than 180°, the folded core structure exhibits capability for fluid flow along the width of the folded core structure as well as along the length of the folded core structure. Preferably, the first primary surface and/or the second primary surface is composed of a sheet of material which is laminated to the plurality of consecutive 3D-structures formed by plastic deformation forming a predefined angle of more than 0° and less than 180° in the folded core structure. The sheet of material which is laminated to the plurality of consecutive 3D-structures formed by plastic deformation forming a predefined angle of more than 0° and less than 180° in the folded core structure prevents, or at least reduces, deformation of the folded core structure under a compression force applied perpendicular to the first primary surface of the folded core structure.

Preferably, the plurality of consecutive 3D-structures formed by plastic deformation form a predefined angle in the range of 30° to 120°, more preferably in the range of 60° to 90°, in the folded core structure to further reduce deformation of the folded core structure under a compression force applied perpendicular to the first primary surface of the folded core structure while providing sufficient capability for fluid flow along the width of the folded core structure as well as along the length of the folded core structure. A predefined of angle of 60° provides optimum compression resistance in the folded core structure at sufficient capability for fluid flow. A predefined of angle of 90° provides optimum capability for fluid flow in the folded core structure at sufficient compression resistance.

In an embodiment, the sheet of material of which the first primary surface and/or the second primary surface is composed is a polymeric film. The polymeric film may comprise any polymer which is suitable to be laminated to the material comprised in the uncut flat body which is deformed into plurality of consecutive 3D-structures.

Preferably, the polymeric film is a permeable polymeric film enabling fluid flow perpendicular to the first primary surface of the folded core structure.

In an embodiment, the sheet of material of which the first primary surface and/or the second primary surface is composed comprises at least one layer comprising fibers, which is preferably selected from the group consisting of a woven fabric, a knitted fabric, a nonwoven, a woven scrim or a laid scrim.

In an embodiment, the sheet of material of which the first primary surface and/or the second primary surface is composed comprises at least one layer comprising fibers, which is a nonwoven. A nonwoven enables fluid flow perpendicular to the first primary surface of the folded core structure. Preferably, the fibers comprised in the nonwoven are filaments increase the strength of the sheet of material to improve the dimensional stability of the folded core structure by reducing deformation of the folded core structure under a compression force applied perpendicular to the first primary surface of the folded core structure.

In an embodiment, the plurality of consecutive 3D-structures formed by plastic deformation are folded to an angle of 180° to provide an array of adjacent cell structures, the array extending over the length of the folded core structure and extending over the width of the folded core structure, the cell structures in the array being arranged in a series of adjacent rows of cell structures extending over the width of the folded core structure, the array comprising a row of first cell structures and a row of second cell structures, wherein the cell structures of the row of second cell structures are in direct contact with the cell structures of the row of first cell structures, wherein the cell structures of the row of second cell structures have a height, H₂, which is greater than the height, H₁, of the cell structures of the row of first cell structures characterized in that the difference in height H₂ of the row of second cell structures and the height H₁ of the row of first cell structures is a discrete step. A discrete step is understood to mean that the height of the cell structures of the folded core structure is increased stepwise from the row of first cell structures having a height H₁ to the row of second cell structures having a height H₂, and not by a gradual change in height.

As the plurality of consecutive 3D-structures formed by plastic deformation are folded to an angle of 180°, the cells walls of the cell structures will be oriented perpendicular to the plane of the folded core structure, thereby configuring the first primary surface and/or the second primary surface to provide dimensional stability under a compression force applied perpendicular to the first primary surface of the folded core structure.

FIG. 6 is a schematic top view representation of an exemplary core structure consisting of an array of adjacent hexagonal cells, the array extending in a length direction (MD) and in a width direction (CMD) of the core structure.

The core structure of FIG. 6 consists of an array of adjacent hexagonal cells comprising rows of first cell structures having a height H₁ extending in the width direction of the folded core structure and rows of second cell structures having a height H₂ extending in the width direction of the folded core structure. One row of first cell structures having a height H₁ has been indicated by a grey filling of the hexagonal cells. One row of second cell structures having a height H₂ is indicated by a vertical hatching of the hexagonal cells in FIG. 6. The cell structures of the row of second cell structures are in direct contact with the cell structures of the row of first cell structures.

The cell walls of the cell structures of the row of first cell structures are formed by cell walls defining the circumference of the individual first cell structures, wherein all the cell walls of the first cell structures having a constant height H₁, and the cell structures of the row of second cell structures are formed by cell walls defining the circumference of the individual second cell structures, all the cell walls of the second cell structures having a constant height H₂.

It is noted that the row of hexagonal cells indicated by a horizontal hatching of the hexagonal cells in FIG. 1 comprises cell walls having a height H₁ as well as cell walls having a height H₂.

FIG. 7 is a schematic side view representation of the exemplary core structure of FIG. 6 along line A-A. The core structure comprises rows of first cell structures having a height H₁ and rows of second cell structures having a height H₂, which is higher than the height H₁.

FIG. 7 also schematically depicts that the difference in height H₂ of the row of second cell structures and the height H₁ of the row of first cell structures is formed by a discrete step, and not by a gradual change in height.

The cell structures of the row of first cell structures in the array of adjacent cell structures may be formed by cell walls defining the circumference of the individual first cell structures, all the cell walls of the first cell structures having a constant height H₁, and the cell structures of the row of second cell structures may be formed by cell walls defining the circumference of the individual second cell structures, all the cell walls of the second cell structures having a constant height H₂. The upper edges of the cell walls of the cell structures of the row of second cell structures are thus located in a single plane of the first primary surface which enables improved bonding to a cover layer, in particular to a planar cover layer as all the upper edges of the cell walls will be in contact with the cover layer.

In an embodiment, the plurality of consecutive 3D-structures formed by plastic deformation are folded to an angle of 180° to provide an array of adjacent cell structures, the array extending over the length of the folded core structure and extending over the width of the folded core structure, the cell structures in the array being arranged in a series of adjacent rows of cell structures extending over the width of the folded core structure, the folded core structure comprising in the array of adjacent cell structures one or more further rows of first cell structures having a height H₁ and/or comprising the folded core structure comprises one or more further rows of second cell structures having a height H₂.

The rows of second cell structures having a height H₂ may be spaced apart in the array of adjacent cell structures by at least 1 row of first cell structures having a height H₁, preferably by at least 2, more preferably by at least 3, even more preferably by at least 5, most preferably by at least 10 rows of first cell structures having a height H₁.

However, the folded core structure may comprise rows of second cell structures having a height H₂ and rows of first cell structures having a height H₁ in any desirable order to optimize the core structure with respect to local resilience for any conceivable application. For example, the folded core structure may comprise a series of two rows of second cell structures having a height H₂, two rows of first cell structures having a height H₁, and two rows of second cell structures having a height H₂.

The folded core structure may comprise rows of second cell structures having a height H₂ and rows of first cell structures having a height H₁ in any non-regular order, such as for example a series of one row of second cell structures having a height H₂, five rows of first cell structures having a height H₁, and two rows of second cell structures having a height H₂, or in any other conceivable random order.

The resilience of the folded core structure and/or the capability for fluid flow along the width of the folded core structure can be adjusted by varying the number of rows of second cell structures having a height H₂ per unit length of the core structure.

In a preferred embodiment, the array of adjacent cell structures in the folded core structure consists for at least 15% of first cell structures having a height H₁, preferably for at least 25%, more preferably for at least 50% of first cell structures having a height H₁ to provide sufficient compression resistance at increased loads.

The folded core structure according to the present invention may comprise one or more further rows of second cell structures having a height H₂. In a preferred embodiment, the array of adjacent cell structures in the folded core structure consists for at least 5% of second cell structures having a height H₂, preferably for at least 10%, more preferably for at least 15% of second cell structures having a height H₂ to provide sufficient resilience of the folded core structure. Preferably, the array of adjacent cell structures in the core structure consists for at most 25% of second cell structures having a height H₂, preferably for at most 20%, more preferably for at most 15% of second cell structures having a height H₂ to optimize the resilience of the folded core structure.

In an embodiment, the plurality of consecutive 3D-structures formed by plastic deformation are folded to an angle of 180° to provide an array of adjacent cell structures, the array extending over the length of the folded core structure and extending over the width of the folded core structure, the cell structures in the array being arranged in a series of adjacent rows of cell structures extending over the width of the folded core structure, the folded core structure comprising in the array of adjacent cell structures at least 2 rows of second cell structures having a height H₂ per meter length of the folded core structure, preferably at least 3, more preferably at least 5, even more preferably at least 10, most preferably at least 15 rows of second cell structures having a height H₂ per meter length of the folded core structure.

The resilience of the core structure and/or the capability for fluid along the width of the folded core structure can be adjusted by varying the height of the discrete step between the height H₂ of the row(s) of second cell structures and the height H₁ of the row(s) of first cell structures. The difference of the height H₂ of the row of second cell structures in the array of adjacent cell structures and the height H₁ of the row of first cell structures in the array of adjacent cell structures may be at least 2 mm, preferably at least 4 mm, more preferably at least 6 mm, even more preferably at least 8 mm, most preferably at least 10 mm.

In an embodiment, the difference of the height H₂ of the row(s) of second cell structures and the height H₁ of the row(s) of first cell structures is at most 20 mm, preferably at most 16 mm, more preferably at most 14 mm, even more preferably at most 12 mm, most preferably at most 10 mm. Reducing the difference of the height H₂ of the row(s) of second cell structures and the height H₁ of the row(s) of first cell structures enables for example to prevent crack formation in hard flooring, such as for example a wooden floor or a floating cement floor placed on top of the folded core structure, under high loads while providing resilience at low or moderate loads. At moderate loads or compressive forces, the row(s) of second cell structures having a height H₂ will absorb at least part of the compressive energy to provide resilience. At increasing loads or compressive forces the height of the row(s) of second cell structures will be reduced or the row(s) of second cell structures may even collapse, and the loads or compressive forces will be absorbed by all the cell structures comprised in the folded core structure, i.e. by the row(s) of second cell structures and the row(s) of first cell structures.

In an embodiment, the height H₁ of the row(s) of first cell structures in the folded core structure is at least 2 mm, preferably at least 5 mm, more preferably at least 8 mm, even more preferably at least 10 mm, most preferably at least 15 mm.

Preferably, the height H₁ of the row(s) of first cell structures in the folded core structure is at most 100 mm, preferably at most 50 mm, more preferably at most 25 mm, even more preferably at most 20 mm, most preferably at most 15 mm.

In an embodiment, the height H₂ of the row of second cell structures in the folded core structure is at least 4 mm, preferably at least 7 mm, more preferably at least 10 mm, even more preferably at least 12 mm, most preferably at least 17 mm.

Preferably, the height H₂ of the row(s) of second cell structures in the folded core structure is at most 120 mm, preferably at most 70 mm, more preferably at most 45 mm, even more preferably at most 40 mm, most preferably at most 35 mm.

The folded core structure may comprise one or more rows of third cell structures having a height, H₃, which is greater than the height H₁ of the cell structures of the row of first cell structures and which is smaller than the height H₂ of the cell structures of the row of second cell structures. By including one or more rows of third cell structures having a height H₃ which is between the height H₂ of the row(s) of second cell structures and the height H₁ of the row(s) of first cell structures, the resilience of the core structure can be fine-tuned for specific applications in response to the loads applied onto the core structure.

The thickness of the cell walls defining the circumference of the individual second cell structures having a height H₂ may be varied widely for example to optimize the resilience of the core structure at moderate loads. Decreasing the thickness of the cell walls defining the circumference of the individual second cell structures, increases the resilience of the core structure at small to moderate loads.

Increasing the thickness of the cell walls defining the circumference of the individual second cell structures, prevents premature collapse of the second cell structures in the core structure at increasing loads.

In an embodiment, the thickness of the cell walls defining the circumference of the individual second cell structures may be in the range of 0.1 mm to 1.0 mm.

Preferably, the thickness of the cell walls defining the circumference of the individual second cell structures is in the range of 0.2 mm to 0.5 mm, more preferably in the range of 0.3 mm to 0.4 mm.

In a preferred embodiment, one end of all the cell structures comprised in the array of adjacent cell structures forming the folded core structure are located in a single plane to provide a planar surface, as has been schematically depicted in FIG. 7. Generally, this planar surface will be the second primary surface of the folded core structure when in use. Consequently, the opposing ends of the cell structures comprised in the array of adjacent cell structures forming the core structure will not all be located in a single plane as the cell structures of the row(s) of second cell structures have a height H₂, which is greater than the height H₁ of the cell structures of the row of first cell structures. The opposing ends of the row(s) of first cell structures will be located a plane of the first secondary surface which is located plane-parallel to the second primary surface at a distance H₁ from second primary surface, and the opposing ends of the row(s) of second cell structures will be located in a plane which is located plane-parallel to the second primary surface at a distance H₂ from the second primary surface.

However, in another embodiment one end of all the cell structures comprised in the array of adjacent cell structures forming the core structure are not located in a single plane to enable to provide a core structure with rows of second cell structures having a height H₂ protruding from both surfaces of the core structure.

FIG. 8 is a schematic side view representation of an exemplary core structure wherein one end of all the cell structures comprised in the array of adjacent cell structures forming the core structure are not located in a single plane, thus providing a folded core structure comprising a first primary surface, a second primary surface, first secondary surfaces and second secondary surfaces.

In an embodiment, the plurality of consecutive 3D-structures formed by plastic deformation are folded to an angle of 180° to provide an array of adjacent cell structures, the array extending over the length of the folded core structure and extending over the width of the folded core structure, the cell structures in the array being arranged in a series of adjacent rows of cell structures extending over the width of the folded core structure constitute a monolithic structure.

The folded core structure obtained by folding the plurality of consecutive 3D-structures formed by plastic deformation are folded to an angle of 180° to provide an array of adjacent cell structures, the array extending over the length of the folded core structure and extending over the width of the folded core structure, the cell structures in the array being arranged in a series of adjacent rows of cell structures extending over the width of the folded core structure may be applied in a composite article comprising the folded core structure and a cover layer in direct contact with the folded core structure, which is preferably oriented plane-parallel to the folded core structure and preferably being connected to the folded core structure.

In a preferred embodiment, a folded core structure is provided, which has a capability for fluid flow at least along the width of the folded core structure while having sufficient dimensional stability under a compression force applied perpendicular to the plane of the folded core structure, comprising a plurality of consecutive 3D-structures formed by plastic deformation form a predefined angle of more than 0° and less than 180°, and comprising a plurality of consecutive 3D-structures formed by plastic deformation folded to an angle of 180° to provide an array of adjacent cell structures. In this embodiment a part of the 3D-structures formed by plastic deformation is thus fully folded to 180° such that the folded core structure comprises a honeycomb core structure of adjacent cell structures and a part of the 3D-structures formed by plastic deformation is folded to a predetermined angle between 0° and 180° such that the folded core structure has capability for fluid flow in at least one direction in the plane of the folded core structure.

The considerations regarding the shape of the 3D-structures formed in the uncut flat body, the thickness of the uncut flat body, the thickness of the plastically deformed flat body, the material of the flat body, the preferred values of the predefined angle of more than 0° and less than 180°, the (difference in) height of the adjacent cells of in the array of adjacent cell structures, as discussed above remain likewise applicable for the folded core structure wherein a part of the 3D-structures formed by plastic deformation is thus fully folded to 180° such that the folded core structure comprises a honeycomb core structure of adjacent cell structures and a part of the 3D-structures formed by plastic deformation is folded to a predetermined angle between 0° and 180° such that the folded core structure has capability for fluid flow in at least one direction in the plane of the folded core structure.

The folded core structure thus combines the advantages of a fully folded core structure with advantages of fluid flow in at least one direction in the plane of the folded core structure, which may for example advantageously be used in green roof applications. The array of adjacent cell structures may for example store rain water in the green roof system and can only be emptied by roots of plants growing above the folded core structure, while the 3D-structures formed by plastic deformation folded to a predetermined angle between 0° and 180° ensure sufficient drainage capacity, e.g. for excess rain water. By selecting the ratio between 3D-structures folded to an angle of 180° and 3D-structures folded to an angle between 0° and 180°, and/or by selecting the dimensions of the 3D-structures, the storage capacity for rain water and the drainage capacity can be tailored to meet the demands which may depend on local weather conditions. An increased ratio between 3D-structures folded to an angle of 180° and 3D-structures folded to an angle between 0° and 180° increases the water storage capacity for arid weather conditions, whereas a decreased between 3D-structures folded to an angle of 180° and 3D-structures folded to an angle between 0° and 180° increases the drainage capacity for humid weather conditions.

A process for providing a folded core structure which has a capability for fluid flow at least along the width of the folded core structure while having sufficient dimensional stability under a compression force applied perpendicular to the plane of the folded core structure is provided, the process comprising the steps of providing an uncut flat body, plastically deforming the uncut flat body to form a plurality of consecutive 3D-structures and connecting areas, the connecting areas being formed between consecutive 3D-structures, folding the consecutive 3D-structures towards each other to a predefined angle to form a first primary surface and a second primary surface oriented plane-parallel to the first primary surface, wherein the first primary surface and the second primary surface are defined by a length and a width of the folded core structure, and to form a first secondary surface extending over the entire width of the folded core structure and extending over a part of the length of the folded core structure, wherein the first secondary surface is oriented parallel to the first primary surface and wherein the first secondary surface is located at a distance from the first primary surface between the first primary surface and the second primary surface, to provide a channel for fluid flow at least along the width of the folded core structure, the circumference of the channel for fluid flow being formed by the first secondary surface, the connecting areas or a part of the 3D-structures, and the first primary surface, and configuring the first primary surface and/or the second primary surface such to provide dimensional stability under a compression force applied perpendicular to the first primary surface of the folded core structure.

Preferably, the process for manufacturing the resilient core structure according to the invention is a continuous process.

In an embodiment of the process, folding is performed such that the consecutive 3D-structures form a predefined angle of more than 0° and less than 180° and wherein a sheet of material is laminated to the plurality of consecutive 3D-structures formed by plastic deformation to form the first primary surface and/or the second primary surface. One could consider that the consecutive 3D-structures are not fully folded together in the core structure when consecutive 3D-structures form a predefined angle of more than 0° and less than 180° in the folded core structure. As the 3D-structures formed by plastic deformation form a predefined angle of more than 0° and less than 180°, the folded core structure exhibits capability for fluid flow along the width of the folded core structure as well as along the length of the folded core structure. The sheet of material which is laminated to the plurality of consecutive 3D-structures formed by plastic deformation forming a predefined angle of more than 0° and less than 180° in the folded core structure prevents, or at least reduces, deformation of the folded core structure under a compression force applied perpendicular to the first primary surface of the folded core structure.

Preferably, folding is performed such that the consecutive 3D-structures form a predefined angle that the plurality of consecutive 3D-structures formed by plastic deformation form a predefined angle in the range of 30° to 120°, more preferably in the range of 60° to 90°, in the folded core structure to further reduce deformation of the folded core structure under a compression force applied perpendicular to the first primary surface of the folded core structure while providing sufficient capability for fluid flow along the width of the folded core structure as well as along the length of the folded core structure.

The length of the folded core structure provided by the process according to the invention depends on the length of the uncut flat body provided in the process and the thickness of the folded core structure and the predefined angle to which the consecutive 3D-structures formed by plastic deformation are folded. The length of the folded core structure generally will be at least 0.5 m, preferably at least 1 m, more preferably at least 5 m, more preferably at least 10 m, even more preferably at least 50 m. The length of the folded core structure can be indefinite in case of a continuous supply of the uncut flat body.

The thickness of the folded core structure may be varied widely, and depends on the length of the consecutive 3D-structures between consecutive folding lines and the predefined angle formed by consecutive 3D-structures. When the predefined angle approaches to 180°, the thickness of the folded core structure will approach to the length of the 3D-structures between consecutive folding lines. When the predefined angle approaches to 180°, the thickness of the folded core structure will approach to the thickness of the plastically deformed uncut flat body.

In an embodiment, the thickness of the folded core structure is at least 3 mm, preferably at least 10 mm, more preferably at least 30 mm to provide sufficient capability for fluid flow, at least along the width of the folded core structure. When the thickness of the folded core structure is less than 3 mm, the flow resistance will become too high to allow sufficient capability for fluid flow.

The maximum thickness of the folded core structure may vary widely. In an embodiment, the thickness of the folded core structure is at most 150 mm, preferably at most 100 mm. When the thickness of the folded core structure is more than 150 mm, rolling of the folded ore structure into a roll will become increasingly difficult.

The width of the folded core structure may be varied widely, but preferably the width of the core structure is in the range of 0.1 to 5.0 m, preferably in the range of 0.2 to 1.5 m.

In an embodiment, the uncut flat body comprises a thermoplastic polymer to enable plastic deformation. Preferably, the uncut flat body is composed of at least 50 wt. % of a thermoplastic polymer, more preferably of at least 75 wt. %, even more preferably of at least 90 wt. %, most preferably of at least 95 wt. % of a thermoplastic polymer.

The thermoplastic polymer comprised in the uncut flat body may be any thermoplastic polymer, including but not limited to a polyamide, such as for example a polyamide-6 (PA6), a polyamide-6,6 (PA6,6) or a polyamide-4,6 (PA4,6), a polyester, such as for example a polyethylene terephthalate (PET), a polybutylene terephthalate (PBT), a polytrimethylene terephthalate (PTT), polyethylene naphthalate (PEN) or polylactic acid (PLA), a polyolefin, such as for example a polyethylene (PE), a polypropylene (PP), polyphenylene sulfide (PPS), a polystyrene (PS), any copolymer thereof and/or any combination of two or more of these polymers.

The thermoplastic polymer comprised in the uncut flat body may be selected depending on the desired mechanical properties of the folded core structure and/or on the conditions, including for example temperature and humidity, in the envisaged application of the folded core structure.

In an embodiment, the thermoplastic polymer comprised in the uncut flat body comprises a polyolefin, in particular a polypropylene.

In another embodiment, the thermoplastic polymer comprised in the uncut flat body comprises a polyester, in particular a polyethylene terephthalate.

The uncut flat body preferably is a continuous layer, which allows that the 3D-structures to be plastically formed by vacuum thermoforming processes.

The sheet of material laminated to the plurality of consecutive 3D-structures formed by plastic deformation may in principle be made of any material. The sheet of material laminated to the plurality of consecutive 3D-structures formed by plastic deformation could for example be a sheet of aluminum, a sheet of wood or a fibreboard providing the folded core structure with high stiffness.

In an embodiment of the process, the sheet of material laminated to the plurality of consecutive 3D-structures formed by plastic deformation is a polymeric film. The polymeric film may comprise any polymer which is suitable to be laminated to the material comprised in the uncut flat body which is deformed into plurality of consecutive 3D-structures and/or which enables that the folded core structure may be rolled up into a roll for transportation.

The polymeric film laminated to the plurality of consecutive 3D-structures formed by plastic deformation may be a continuous polymeric film to prevent fluid flow in the normal direction into the folded core structure from the side of the first primary surface.

Preferably, the polymeric film laminated to the plurality of consecutive 3D-structures formed by plastic deformation is a permeable polymeric film enabling fluid flow perpendicular to the first primary surface of the folded core structure. The permeable polymeric film may be a film provided with perforations, the perforations preferably having an area in the range of 1 mm² to 50 mm², more preferably in the range of 10 mm² to 30 mm².

In an embodiment, the polymeric film laminated to the plurality of consecutive 3D-structures formed by plastic deformation comprises a thermoplastic polymer. Preferably, the polymeric film is composed of at least 50 wt. % of a thermoplastic polymer, more preferably of at least 75 wt. %, even more preferably of at least 90 wt. %, most preferably of at least 95 wt. % of a thermoplastic polymer. In an embodiment, the polymeric film is composed for 100 wt. % of a thermoplastic polymer.

The thermoplastic polymer comprised in the polymeric film laminated to the plurality of consecutive 3D-structures formed by plastic deformation may be any thermoplastic polymer, including but not limited to a polyamide, such as for example a polyamide-6 (PA6), a polyamide-6,6 (PA6,6) or a polyamide-4,6 (PA4,6), a polyester, such as for example a polyethylene terephthalate (PET), a polybutylene terephthalate (PBT), a polytrimethylene terephthalate (PTT), polyethylene naphthalate (PEN) or polylactic acid (PLA), a polyolefin, such as for example a polyethylene (PE) or a polypropylene (PP), polyphenylene sulfide (PPS), a polystyrene (PS), any copolymer thereof and/or any combination of two or more of these polymers.

The thermoplastic polymer comprised in the polymeric film laminated to the plurality of consecutive 3D-structures formed by plastic deformation may be selected depending on the desired mechanical properties of the folded core structure and/or on the conditions, including temperature and humidity, in the envisaged application of the folded core structure.

In an embodiment, the thermoplastic polymer comprised in the polymeric film comprises a polyolefin, in particular a polypropylene.

In another embodiment, the thermoplastic polymer comprised in the polymeric film comprises a polyester, in particular a polyethylene terephthalate.

In an embodiment of the process, the sheet of material laminated to the plurality of consecutive 3D-structures formed by plastic deformation comprises at least one layer comprising fibers.

In an embodiment of the process, the sheet of material laminated to the plurality of consecutive 3D-structures formed by plastic deformation comprises at least one layer comprising fibers, which is preferably selected from the group consisting of a woven fabric, a knitted fabric, a nonwoven, a woven scrim or a laid scrim.

The at least one layer comprising fibers comprised in the sheet of material laminated to the plurality of consecutive 3D-structures formed by plastic deformation may be a permeable layer to allow fluid flow in the normal direction into the folded core structure from the side of first primary surface, such that the folded core structure has capability for fluid flow in the normal direction of the folded core structure. Furthermore, the layer comprising fibers in the sheet of material laminated to the plurality of consecutive 3D-structures formed by plastic deformation may provide increased modulus and/or increased tensile strength to the folded core structure in the length and/or width direction of the folded core structure.

The term fibers is understood to refer both to staple fibers and to filaments. Staple fibers are fibers which have a specified, relatively short length in the range of 2 to 200 mm. Filaments are fibers having a length of more than 200 mm, preferably more than 500 mm, more preferably more than 1000 mm. Filaments may even be virtually endless, for example when formed by continuous extrusion and spinning of a filament through a spinning hole in a spinneret.

The fibers may have any cross sectional shape, including round, trilobal, multi-lobal or rectangular, the latter exhibiting a width and a height wherein the width may be considerably larger than the height, so that the fiber in this embodiment is a tape. Furthermore, said fibers may be mono-component, bicomponent or even multi-component fibers.

In an embodiment, the layer comprising fibers is a nonwoven. The nonwoven may be any type of nonwoven, such as for example staple fiber nonwovens produced by well-known processes, such as carding processes, wet-laid processes or air-laid processes or any combination thereof. The nonwoven may also be a nonwoven composed of filaments produced by well-known spunbonding processes wherein filaments are extruded from a spinneret and subsequently laid down on a conveyor belt as a web of filaments and subsequently bonding the web to form a nonwoven, or by a two-step process wherein filaments are spun and wound on bobbins, preferably in the form of multifilament yarns, followed by the step of unwinding the multifilament yarns and laying the filaments down on a conveyor belt as a web of filaments and bonding the web to form a nonwoven.

In an embodiment, the fibers in the nonwoven are fibers having a linear density in the range of 1 to 25 dtex, preferably in the range of 2 to 20 dtex, more preferably in the range of 5 to 15 dtex, most preferably in the range of 5 to 10 dtex to provide processing stability and mass regularity in the nonwoven while maintaining sufficient structure openness for providing capability for fluid flow in the normal direction of the core structure. The unit dtex defines the fineness of the fibers as their weight in grams per 10000 meter.

The nonwoven may be composed of thermoplastic fibers for at least 50 wt. % of the total weight of fibers in the nonwoven, preferably for at least 75 wt. %, more preferably for at least 90 wt. %, even preferably for at least 95 wt. %. Increasing the amount of thermoplastic fibers in the nonwoven layer of fibers increases the tensile strength and/or tear resistance and/or increases the flexibility of the sheet of material laminated to the plurality of consecutive 3D-structures formed by plastic deformation.

In an embodiment the nonwoven is composed for 100 wt. % of thermoplastic fibers of the total weight of fibers in the nonwoven.

The thermoplastic polymer from which the thermoplastic fibers in the nonwoven are composed may be any type of thermoplastic polymer capable of withstanding the temperatures encountered in the envisaged application of the core structure. The thermoplastic fibers in the nonwoven may comprise a polyester, such as for example polyethylene terephthalate (PET) (based either on DMT or PTA), polybutylene terephthalate (PBT), polytrimethylene terephthalate (PTT), polyethylene naphthalate (PEN) and/or polylactic acid (PLA), a polyamide, such as for example a polyamide-6 (PA6), polyamide-6,6 (PA6,6), a polyamide-4,6 (PA4,6) and/or a polyamide-4,10 (PA4,10), a polyolefin, such as for example a polyethylene (PE) or a polypropylene (PP), a polyphenylene sulfide (PPS), a polystyrene (PS), and/or any copolymer or any blend thereof.

In an embodiment of the process, the sheet of material of which the first primary surface and/or the second primary surface is composed comprises at least one layer comprising fibers, which is a nonwoven. A nonwoven enables fluid flow perpendicular to the first primary surface of the folded core structure. Preferably, the fibers comprised in the nonwoven are filaments provide increases tensile strength and/or tear strength to the sheet of material to improve the dimensional stability of the folded core structure by reducing deformation of the folded core structure under a compression force applied perpendicular to the first primary surface of the folded core structure.

In an embodiment of the process, plastically deforming of the uncut flat body is performed such that two consecutive 3D-structures are formed having a length corresponding to H₂ and two consecutive 3D-structures are formed having a length corresponding to H₁, and wherein folding is performed such that the consecutive 3D-structures form a predefined angle of 180° to provide an array of adjacent cell structures, the array extending over the length of the folded core structure and extending over the width of the folded core structure, the cell structures in the array being arranged in a series of adjacent rows of cell structures extending over the width of the folded core structure, the array comprising a row of first cell structures and a row of second cell structures, wherein the cell structures of the row of second cell structures are in direct contact with the cell structures of the row of first cell structures, wherein the cell structures of the row of second cell structures have a height, H₂, which is greater than the height, H₁, of the cell structures of the row of first cell structures characterized in that the difference in height H₂ of the row of second cell structures and the height H₁ of the row of first cell structures is a discrete step.

In an embodiment of the process, the cell structures of the row of first cell structures are formed by cell walls defining the circumference of the individual first cell structures, all the cell walls of the first cell structures having a constant height H₁, and the cell structures of the row of second cell structures are formed by cell walls defining the circumference of the individual second cell structures, all the cell walls of the second cell structures having a constant height H₂.

In an embodiment of the process, plastically deforming of the uncut flat body is performed such that one or more further sets of two consecutive 3D-structures are formed having a length corresponding to H₂ and one or more further sets of two consecutive 3D-structures are formed having a length corresponding to H₁ and the plurality of consecutive 3D-structures formed by plastic deformation are folded to an angle of 180° to provide an array of adjacent cell structures, the array extending over the length of the folded core structure and extending over the width of the folded core structure, the cell structures in the array being arranged in a series of adjacent rows of cell structures extending over the width of the folded core structure, to form one or more further rows of first cell structures having a height H₁ and/or to form one or more further rows of second cell structures having a height H₂ in the folded core structure.

In an embodiment of the process, plastically deforming of the uncut flat body and folding of the consecutive 3D-structures to form a predefined angle of 180° to provide an array of adjacent cell structures is performed such that the rows of second cell structures having a height H₂ are spaced apart by at least 1 row of first cell structures having a height H₁, preferably by at least 2, more preferably by at least 3, even more preferably by at least 5, most preferably by at least 10 rows of first cell structures having a height H₁.

In an embodiment of the process, plastically deforming of the uncut flat body and folding of the consecutive 3D-structures to form a predefined angle of 180° to provide an array of adjacent cell structures is performed such that the folded core structure comprises at least 2 rows of second cell structures having a height H₂ per meter length of folded core structure, preferably at least 3, more preferably at least 5, even more preferably at least 10, most preferably at least 15 rows of second cell structures having a height H₂ per meter length of the folded core structure.

In an embodiment of the process, plastically deforming of the uncut flat body and folding of the consecutive 3D-structures to form a predefined angle of 180° to provide an array of adjacent cell structures is performed such that the difference of the height H₂ of the row of second cell structures and the height H₁ of the row of first cell structures is at least 2 mm, preferably at least 4 mm, more preferably at least 6 mm, even more preferably at least 8 mm, most preferably at least 10 mm.

In an embodiment of the process, plastically deforming of the uncut flat body and folding of the consecutive 3D-structures to form a predefined angle of 180° to provide an array of adjacent cell structures is performed such that the folded core structure is a monolithic structure. The term monolithic structure is understood to mean that the structure is formed or composed of material without joints or seams.

In a preferred embodiment of the process, a process for folded core structure is provided, which has a capability for fluid flow at least along the width of the folded core structure while having sufficient dimensional stability under a compression force applied perpendicular to the plane of the folded core structure, comprising the step of folding a plurality of consecutive 3D-structures formed by plastic deformation to a predefined angle of more than 0° and less than 180°, and folding a plurality of consecutive 3D-structures formed by plastic deformation folded to an angle of 180° to provide an array of adjacent cell structures. In this embodiment a part of the 3D-structures formed by plastic deformation is thus fully folded to 180° such that the folded core structure comprises a honeycomb core structure of adjacent cell structures and a part of the 3D-structures formed by plastic deformation is folded to a predetermined angle between 0° and 180° such that the folded core structure has capability for fluid flow in at least one direction in the plane of the folded core structure. Preferably, the folding to different predetermined angles is performed by varying the speed of the folding step, e.g. by varying the speed of rollers folding the 3D-structures.

The folded core structure may comprise a further sheet of material plane parallel to the first primary surface of the folded core structure and preferably laminated to the plurality of consecutive 3D-structures formed by plastic deformation connected to the second main surface of the folded core structure in the plane of the second primary surface.

The further sheet of material, may in principle be made of any material, and may be selected from any of the materials described above.

The further sheet of material may also be an adhesive tape which allows to connect the folded core structure onto a substrate.

The further sheet of material may also be a layer of hook & loop mechanical fastener, such as for example Velcro, which allows to releasably connect the folded core structure onto a substrate.

The folded core structure according to the invention may advantageously be used as an acoustic layer under a floating (cementitious) floor or as an acoustic layer under laminate flooring.

The folded core structure according to the invention may advantageously be used as a vibration isolation layer in transport systems.

The folded core structure according to the invention may advantageously be used as a drainage layer.

The folded core structure according to the invention may advantageously be used as an acoustical panel for reducing airborne noise.

The folded core structure according to the invention may advantageously be used as a ventilation layer, e.g. in walls and/or roofs of buildings.

1. A folded core structure formed from an uncut flat body, the folded core structure having a plurality of consecutive 3D-structures formed by plastic deformation and connecting areas formed by the plastic deformation, the folded core structure comprising a first primary surface and a second primary surface oriented plane-parallel to the first primary surface, wherein the first primary surface and the second primary surface are defined by a length and a width of the folded core structure, and comprising a first secondary surface extending over the entire width of the folded core structure and extending over a part of the length of the folded core structure, wherein the first secondary surface is oriented parallel to the first primary surface and wherein the first secondary surface is located at a distance from the first primary surface between the first primary surface and the second primary surface, wherein a channel for fluid flow at least along the width of the folded core structure is provided, the circumference of the channel for fluid flow being formed by the first secondary surface, the connecting areas or a part of the 3D-structures, and the first primary surface, and wherein the first primary surface and/or the second primary surface is/are configured such to provide dimensional stability under a compression force applied perpendicular to the first primary surface of the folded core structure.

2. The folded core structure according to claim 1 wherein the folded core structure comprises more than one first secondary surfaces to provide multiple flow channels for fluid flow along the width of the folded core structure.

3. The folded core structure according to claim 1 wherein the plurality of consecutive 3D-structures formed by plastic deformation form a predefined angle of more than 0° and less than 180°, and wherein the first primary surface and/or the second primary surface is composed of a sheet of material laminated to the plurality of consecutive 3D-structures formed by plastic deformation.

4. The folded core structure according to claim 3 wherein the plurality of consecutive 3D-structures formed by plastic deformation form a predefined angle in the range of 30° to 120°.

5. The folded core structure according to claim 3 wherein the sheet of material of which the first primary surface and/or the second primary surface is composed comprises at least one layer comprising fibers.

6. The folded core structure according to claim 1 wherein the plurality of consecutive 3D-structures formed by plastic deformation are folded to an angle of 180° to provide an array of adjacent cell structures, the array extending over the length of the folded core structure and extending over the width of the folded core structure, the cell structures in the array being arranged in a series of adjacent rows of cell structures extending over the width of the folded core structure, the array comprising a row of first cell structures and a row of second cell structures, wherein the cell structures of the row of second cell structures are in direct contact with the cell structures of the row of first cell structures, wherein the cell structures of the row of second cell structures have a height, H2, which is greater than the height, H1, of the cell structures of the row of first cell structures characterized in that the height of the cell structures of the folded core structure is increased stepwise from the row of first cell structures having a height H1 to the row of second cell structures having a height H2.

7. The folded core structure according to claim 6 wherein the cell structures of the row of first cell structures are formed by cell walls defining the circumference of the individual first cell structures, all the cell walls of the first cell structures having a constant height H1, and the cell structures of the row of second cell structures are formed by cell walls defining the circumference of the individual second cell structures, all the cell walls of the second cell structures having a constant height H2.

8. The folded core structure according to claim 6 wherein the folded core structure is a monolithic structure.

9. A composite article comprising the folded core structure according to claim 6 and a cover layer in direct contact with the folded core structure.

10. A process for providing a folded core structure according to claim 1 comprising the steps of
a) providing an uncut flat body,
b) plastically deforming the uncut flat body to form a plurality of consecutive 3D-structures and connecting areas the connecting areas being formed between consecutive 3D-structures,
c) folding the consecutive 3D-structures towards each other to a predefined angle to form a first primary surface and a second primary surface oriented plane-parallel to the first primary surface, wherein the first primary surface and the second primary surface are defined by a length and a width of the folded core structure, and to form a first secondary surface extending over the entire width of the folded core structure and extending over a part of the length of the folded core structure, wherein the first secondary surface is oriented parallel to the first primary surface and wherein the first secondary surface is located at a distance from the first primary surface between the first primary surface and the second primary surface to provide a channel for fluid flow at least along the width of the folded core structure, the circumference of the channel for fluid flow being formed by the first secondary surface, the connecting areas or a part of the 3D-structures, and the first primary surface,
d) configuring the first primary surface and/or the second primary surface such to provide dimensional stability under a compression force applied perpendicular to the first primary surface of the folded core structure.

11. The process according to claim 10 wherein folding is performed such that the consecutive 3D-structures form a predefined angle of more than 0° and less than 180°, and wherein a sheet of material is laminated to the plurality of consecutive 3D-structures formed by plastic deformation to form the first primary surface and/or the second primary surface.

12. The process according to claim 11 wherein the sheet of material laminated to the plurality of consecutive 3D-structures formed by plastic deformation comprises at least one layer comprising fibers.

13. The process according to claim 10 wherein plastically deforming of the uncut flat body is performed such that two consecutive 3D-structures are formed having a length corresponding to H2 and two consecutive 3D-structures are formed having a length corresponding to H1, and wherein folding is performed such that the consecutive 3D-structures form a predefined angle of 180° to provide an array of adjacent cell structures, the array extending over the length of the folded core structure and extending over the width of the folded core structure, the cell structures in the array being arranged in a series of adjacent rows of cell structures extending over the width of the folded core structure, the array comprising a row of first cell structures and a row of second cell structures, wherein the cell structures of the row of second cell structures are in direct contact with the cell structures of the row of first cell structures, wherein the cell structures of the row of second cell structures have a height, H2, which is greater than the height, Hi, of the cell structures of the row of first cell structures characterized in that the height of the cell structures of the folded core structure is increased stepwise from the row of first cell structures having a height H1 to the row of second cell structures having a height H2.

14. The process according to claim 13 wherein the cell structures of the row of first cell structures are formed by cell walls defining the circumference of the individual first cell structures, all the cell walls of the first cell structures having a constant height H1, and the cell structures of the row of second cell structures are formed by cell walls defining the circumference of the individual second cell structures, all the cell walls of the second cell structures having a constant height H2.

15. The process according to claim 13 wherein the folded core structure is a monolithic structure.

16. An acoustic layer under a floating floor or as an acoustic layer under laminate flooring, an acoustic layer under a cementitious floating floor, a vibration isolation layer in transport systems, a drainage layer, an acoustical panel for reducing airborne noise, or a ventilation layer, comprising the folded core structure according to claim 1.
